(19) United States
(12) Patent Application Publication
(10) Pub. No.: US 2003/0048294 A1
(43) Pub. Date: Mar. 13, 2003

(54) System and method for the creation of interactive display ads

(75) Inventor: John E. Arnold, Westborough, MA (US)

Correspondence Address: HALE AND DORR, LLP, 60 STATE STREET, BOSTON, MA, 02109

(73) Assignee: Switchboard Incorporated

(21) Appl. No.: 10/236,786

(22) Filed: Sep. 6, 2002

Related U.S. Application Data
(60) Provisional application No. 60/318,105, filed on Sep. 7, 2001.

(51) Int. Cl. G09G 5/00

(52) U.S. Cl. 345/738

(57) ABSTRACT

A display advertisement system and method allow a provider of display ads to create templates that can be used to quickly create display ads in an automated manner. Information updates regarding merchants can be received, and display ads are automatically regenerated to include the updated information.

### CROSS-REFERENCE TO RELATED APPLICATION

This application claims priority from U.S. provisional application No. 60/318,105, filed Sep. 7, 2001, which is incorporated herein by reference.

### BACKGROUND OF THE INVENTION

Interactive online systems often use graphic display ads to induce viewers to link to additional information about a merchant business being advertised. In an online yellow pages system, a viewer may be able to see one or more display ads in response to a category and/or location specific query. For example, if a user enters a search for shoe stores in a particular city, display ads, such as ads known as “badges,” may be displayed for merchants in addition to a listing of names, addresses, and phone numbers (white pages information) for those merchants. In an online system, these display ads typically have hyperlinks to allow a user to click-through to a home page or other web page of the merchant.

A display ad typically has one or more images designed to catch a viewer's attention and also to convey some information about the nature of the products or services offered by the merchant, such as a picture of a pizza chef making pizza. Display ads may also contain textual information such as the merchant name, address, phone number, or specialty. It is desirable to vary the appearance of display ads within a given category to better differentiate the businesses and present a more appealing screen to the viewer.

Construction of display ads has typically been done with manual processes requiring a graphics artist, a computerized image management system (e.g., Adobe® Photoshop®), standard digitized images clip art, and fonts. A graphic artist, based upon a knowledge of the category of the business, the name, and other text information, selects appropriate clip art and overlays it directly with formatted text and/or additional images to create a final display ad. Subsequent informational changes, such as a change in address or phone number, require the artist to manually modify, regenerate, and republish the ad.

### SUMMARY OF THE INVENTION

The system and method of the described embodiment of the present invention include the construction of display ad templates, the creation of display ads, and the regeneration of display ads. With the creation of display ad templates, display ads can be rapidly created in an automated manner. If information about a merchant changes and that information is part of the display ad, the embodiment of the system provides for the automated regeneration of the display ad as needed.

The described embodiment can reduce the effort to create different display ads and to regenerate ads as information changes. Large numbers of display ads can be created and regenerated in an automated manner, without human intervention. Other features and advantages will become apparent from the following detailed description, drawings, and claims.

### BRIEF DESCRIPTION OF THE DRAWINGS

FIG. 1 is a block diagram of a method for creating templates, creating display ads from the templates, and regenerating displays ads according to an embodiment of the invention.

FIGS. 2-4 are screen shots illustrating aspects of the embodiment of the invention.

### DETAILED DESCRIPTION

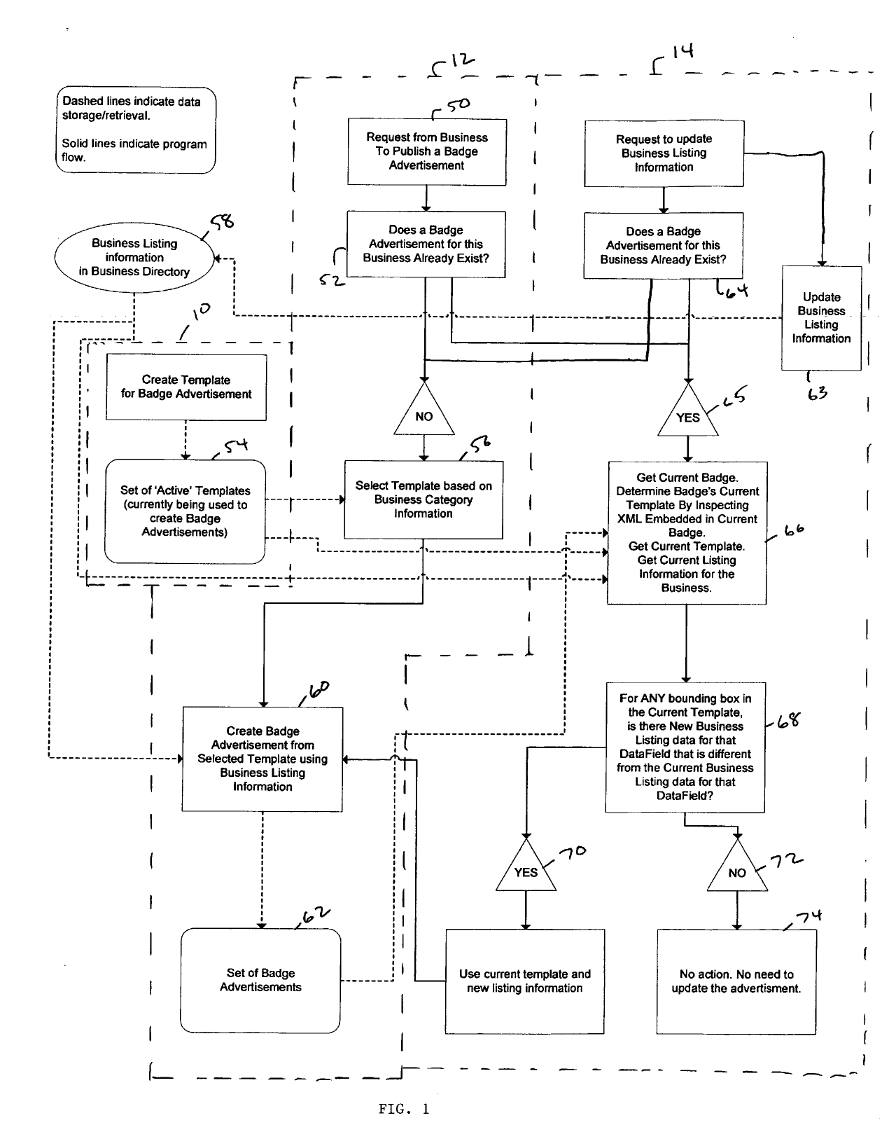

Referring to FIG. 1, the systems and methods of the present invention include the ability to create templates for display ads 10, create display ads with business data using the templates 12, and later regenerate display ads with new business data 14.

Creating a Template

A template is a set of related design elements used to create a graphic output file. These elements preferably include clip art images combined with instructions for the placement of text and/or other graphic elements, including other images placed over a primary background image, to create a single file. The template can later be used to create display ads.

A design artist can select and categorize clip art images, and create a template that can be completely defined by a template language. This process can be done manually or with the support of software tools. The categorization process for the images includes identifying a category for use, such as a type of business, preferably with varying degrees of specificity. For example, an artist can select background images and colors for Italian restaurants and different background images and colors for Chinese restaurants, shoe stores, or accountants. The template language further allows the artist to define regions that can be overlaid onto the primary background image and characteristics of those regions.

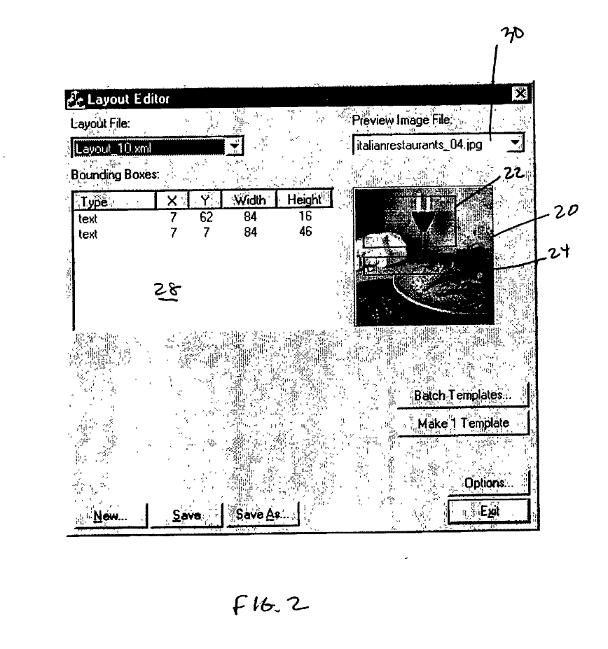

FIG. 2 is a screen shot of a Layout Editor, which is a dialog-based Microsoft Foundation Class application in which the user (designer) specifies a layout to apply to a given JPEG background image. According to one method, to create a template, the user selects a background image 20 from a list 30 of images stored in memory, such as a database. The user can then define regions 22 and 24 in the templates. These regions are referred to as “bounding boxes,” and can be used to hold text or graphics (such as a coupon). Size and locational characteristics of the bounding boxes are defined in a window 28 that shows X and Y coordinates for where the box is, and width and height dimensions to control the layout when the actual display ad is created. As indicated in this example, the first text box, with X=7 and Y=62, corresponds to bounding box 24.

Alternatively, the bounding boxes can be defined for each background image in advance as part of a combined background and bounding box layout. This combination can further reduce the time it takes for a graphic designer to create a new badge template because the bounding boxes need not be defined by the user each time.

Other drop-down boxes allow the user to select a previous layout for editing, or to obtain from an image file one of a number of background images. As shown in FIG. 2, the background image is numbered 04 of the images for Italian restaurants, and there could be many more.

Text or an image (e.g., a badge special offer or coupon graphic) can be placed in each of the bounding boxes.

As shown in the screen shot of the Layout Editor, the user can thus see where the various layout's bounding boxes will be applied when the image is converted into a badge template. The user interface for this process can have a single main window and a few optional dialogs that can be used to provide more information to the application or to access other features of the application.

In practice, a user can edit a text file that describes which background image file should be used, which layout should be used, and the text/image details that should be used for each bounding box, such as font name, font color, and maximum number of lines in the box. Then, the text files and the background image files that they refer to are put into a directory. A program parses the text file into required tagged information, preferably with the results in Extensible Markup Language (XML), and inserts the resulting badge template XML into the given background image file. This background image file with the inserted XML stored in it is then saved as the template.

The Layout Editor also includes a “Batch Templates” button. This selection takes the user to a BatchTemplateMaker application that requests a root directory and an output directory for resulting templates. The root directory contains folders with names exactly matching the category names found in a category file, such as “Accountants.” Each folder name that matches a category name is assumed to contain matching sets of files for each template to be created. Each set of files contains a JPEG file and a text file with the same name (e.g., Accountants_{—}01.jpg and Accountants_{—}01.txt). The text file is structured in such a way that the batch process can read it and parse the various template attributes from it. This parsed template information is stored as an XML string inside the template that is created. The template that is created is given the same name as the JPEG file in the subdirectory. The templates that are created are then stored in a folder specified in the output directory field.

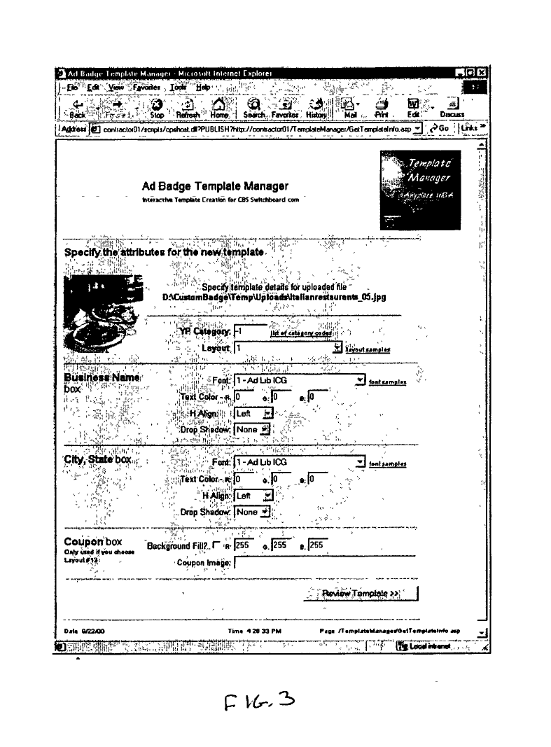

FIG. 3 is a screen shot for a portion of a Template Manager, which is an Active Server Pages (ASP) application that provides the user with a way to interactively create badge templates. The application allows the user to upload JPEG files (used as badge backgrounds) from their machine to the server and then to specify all of the various template attributes.

A user initiates the Template Manager by pointing to an appropriate URL on the server where the application is installed. The user can then type in a path name to a local JPEG file. If the user prefers, he/she can click on a browse button instead of typing in a file name to navigate to a desired file and then to open that file.

When the user has selected the file that he/she wants to use as the background image for a template (which can include the bounding boxes already defined), he/she causes the file to be uploaded to the server and the application advances to a page of template information as shown in FIG. 3. The user can then proceed to define template attributes to be applied to the image file. This template attribute information can include attributes such as font name, drop shadow color, text colors, and background fill colors. The image, text, attribute, and other information are all combined into a standard JPEG format file, thus taking advantage of the JPEG format's capability of storing text in a “comment block” along with graphic information in a single JPEG file. A resulting template can thus be totally contained within, and defined by, one file without the need for synchronizing multiple files containing various parts of the template when changes to the template occur.

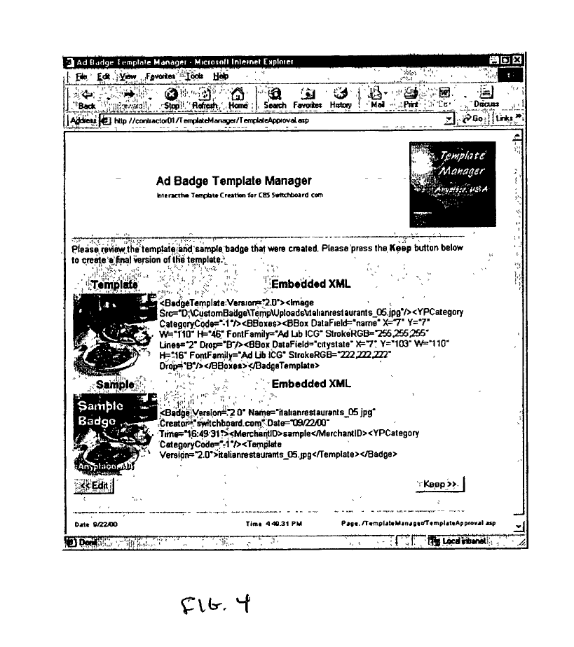

Referring also to FIG. 4, the following are syntax and semantics of an example of Badge Template XML code that is embedded into a “comment block” of a graphics file, preferably a JPEG file, in order to create a display ad template. By embedding this XML into a comment block in a JPEG file, the template is self-contained and self-described and can be moved, renamed, or otherwise processed without needing a separate application to keep the XML data related to the image on which the XML data applies. The resulting badge has enough information that a new badge can be easily regenerated for the merchant using the same template. Thus, if a merchant's phone number changes, a new badge can be created for the merchant using the same template as was used to create this badge.

A BadgeTemplate tag is the root tag of a Badge Template XML document. It has one attribute and three tags that further describe the badge template.

A Version attribute describes what version of the Badge Template syntax/semantics was used to create this template.

A YPCategory tag contains information about the business category to which this template applies. It is described by a required attribute called CategoryCode, which is the code of the business category to which this template applies.

An Image tag described by one required attribute called Src has the full path name of the image file that was used to create the template.

A BBoxes tag contains descriptions of bounding boxes that can be overlaid on the template to create the final display ad. The set of bounding boxes is described by BBox (bounding box) tags inside the BBoxes tag. Each BBox tag describes a bounding box with an area on the display ad where additional text and/or images can be placed. Whether text or an image is placed in the bounding box depends on what data field the bounding box is being used for, although the BBox can be described to support either usage.

In this embodiment, each bounding box is described by the following required attributes: an x position of the bounding box, a y position of the bounding box, the width of the bounding box in pixels, the height of the bounding box in pixels, and a data field (see also FIG. 2 for X, Y, height, and width). The data field is used to match the bounding box to the actual text and/or image that will be rendered in the bounding box during the badge creation process. For example, specifying a bounding box's data field as “name” indicates that the business name is expected to be provided to the template generation component as part of the badge creation process, and will be rendered in this bounding box as part of the badge creation process. The legal values for the data field attributes are the business name as text, the business address as text, the city as text, the state as text, the city and state as “citystate,” the phone number, the default line text, the line1 text, the line2 text, the image1 image, and the image2 image. As shown in FIG. 4, one box has “name” and another has “citystate.” In the “sample” badge in FIG. 4, the “name” is shown as “Sample Badge” and the “citystate” is “Anyplace, Mass.”

Additional optional attributes can be useful when the bounding box is being used to display either text or an image: a horizontal alignment of text or image, a vertical alignment of text or image, degrees of rotation (sweeping an arc counter-clockwise) that should be applied to the text or an image before placing it in the bounding box, a fill color specified as a comma-delimited list of R, G, B decimal values to be used as a fill color, and whether the fill color is used to fill the bounding box before applying the text or image.

Additional attributes are useful when the bounding box is being used to display text: a string name of the font that should be used to display the text, a color specified as a comma-delimited list of R, G, B decimal values (where each value is between 0 and 255 inclusive), the maximum number of lines of text that can be used in this bounding box, whether a black drop shadow, white drop shadow, or no drop shadow should be applied to the text. When the bounding box is being used to display an image, there can also be an attribute for the full path name of the image file.

These design elements for the templates can be created on standard computers (e.g., using MacOS or Windows).

When the user is satisfied with the choices, the user can see a sample badge created with this template information. The user can then keep the sample and thereby create a template. When this process is complete, the application advances to a template approval page.

If the user does not like the choice of template attributes (e.g., font, color, drop shadow, etc.), the user can edit by going back to a template information page. Once there, the user can make whatever changes he/she wants and again review the template to see the new results.

A template approval page shows the template file and the XML string that is embedded in it. This can be useful for debugging any XML bugs that may get injected into the template code. It also shows a sample badge created with the template and the XML string that is embedded in it.

When the user is satisfied with the template, pressing a Keep button moves the generated template to the proper area on the server and advances the user to a template created page.

Creating a Badge from a Template

Referring back to FIG. 1, at a later time in response to a request from a business (or other entity) for a badge advertisement 50, the system determines if a badge already exists 52. If not, the template can be automatically selected 56 from a set of active templates 54, based upon certain criteria, for use with a particular merchant listing. For example, a merchant can be categorized or can itself indicate a preferred category (e.g., from a list), which causes the system to retrieve one of a number of templates for that category. The category of most specificity is preferred—e.g., type of restaurant, rather than just “restaurant” if possible. The system can have rules for determining a preferred category if multiple categories are indicated. This selection can thus be done in an automated manner without human intervention.

From among a number of available templates, one is selected. This selection can be done through random number generation, or through stepping through the templates one at a time, thereby effectively producing a least recently used system. For example, there may be 10 templates for pizza shops, each with a different look. With random or stepped selection, the ads on a page of pizza shops will more likely look different. The system can further check to make sure other ads for businesses in a close geographic location do not share one template.

Using predefined region and text field information in the template, actual listing data (e.g., white pages information, such as business name, address, phone number, etc.) is overlaid over the clip art image and a display ad, ready for viewing on the Internet, is rendered. The display ad can be rendered into any number of standard or proprietary graphics formats (e.g., PNG, GIF). The preferred implementation, however, generates JPEG files. The rendered graphic contains all the necessary information as part of the actual graphic image and does not need to be able to store non-graphical text information for the purpose of creating a badge ad. As such, the generated graphic can be displayed on another computer using industry standard software. In typical cases, this is just a web browser or word processing program that is capable of displaying the graphic file type of the generated graphic. Rendering can occur well ahead of queries made by a viewer or dynamically following the query following a “just in time” model.

Large numbers of badges can thus be created in an automated manner through information received by any means. The information received can be from phone or fax and manually entered into the system to create the badge, or can be provided one at a time or in a large group through electronic means. If provided in bulk electronically, the system preferably includes a front end that parses this information to identify the information for display, and then causes the automatic creation of the display ads. The process for creating many ads can thus be done in an automated manner.

If one searches for a category, there could be many different display ads. The system may check in advance to eliminate or reduce duplication of backgrounds for business in the same geographic area. Alternatively, the system can check other ads displayed at the same time, and regenerate an ad before it is displayed by using a different template. For example, if there are 10 shoe stores in a community and 20 templates, the system can confirm that a randomly selected template is unique compared to other ads that it is likely to be displayed with.

When text is provided to the bounding boxes, it can be done in an automated and optimized manner, based on criteria provided to the system. For example, there can be a desired relationship between the name of the business and other information, or the name size can be maximized to allow some room for other information.

The following describes the syntax and semantics of Badge XML code to be embedded into a JPEG file that is the output of the custom badge creation process. A badge with this XML will be created by applying some business information about a particular merchant to a badge template file (that is, a JPEG file with an embedded Badge Template XML description of the bounding boxes, etc. for that template).

As shown in FIG. 4, a Badge tag is the root tag of a Badge XML document. It has 5 attributes and 3 tags that further describe the badge. The attributes are version, file name used when this badge was generated, creator, the date this badge was generated, and the time this badge was generated. The tags include a MerchantID tag that contains the identification of a merchant for which this badge was created, a YPCategory tag to describe the business category to which this badge applied, and a Template tag that contains information about the BadgeTemplate that was used to generate this badge. The value in the MerchantID tag is intended to be used to get updated merchant information if this badge is used as input to a future badge regeneration process. The YPCategory tag is described by the attribute CategoryCode, which is a code of the business category to which this badge applies. In practice, this category code is the category code of the template that was used to generate this badge. The Template tag value is the file name of the BadgeTemplate that was used to generate this badge.

There are 3 attributes that can provide additional information about the template: a BadgeTemplate version number of the template that was used, if the template used a bounding box to specify the “image1” data field (used to specify an optional image such as a coupon), a full path name of the image that was used is specified as the value of the Template's Image1 attribute, and if the template used a bounding box to specify an “image2” data field, a full path name of the image that was used is specified as the value of the Template's Image2 attribute. (The image attributes are used to make sure a regenerated badge based on this template can use the same image in case those images are selected randomly or not stored with the template.)

When a badge template has been selected, the badge generation component is initiated. The badge generation component has an application programming interface (API) that allows the calling program to load a template for use, assign values to placeholders represented by the bounding boxes, and create a badge output file. For example, a badge template has a background image and XML representing bounding boxes for the business name, the city/state of the business, and an overlaid image. When the template is selected, the badge generation component's API is used to load the template (specified with its file name, such as PizzaRestaurants001.jpg) for use. Then, the API is used to specify information about the business derived from its listing 58 or other provided information. For example, the API would be used to specify the business name provided as a string, such as John's Pizza Restaurant, the address provided as a string, such as 1 Main Street, the city and state each provided as a string, a phone number provided as an unformatted string, and an image file name, such as a savings coupon provided as a path/file name of the file, such as C:\BadgeImagery\DollarOff.jpg.

Once all of the business information has been provided to the badge generation component and the template has been specified, the calling program uses the API to create an in-memory representation of the fully-realized graphic ad by a call to OverlayBadge. During its processing of OverlayBadge, the badge generation component retrieves the badge template XML from the template file that has been loaded and iterates over each of the bounding boxes in it.

As each text bounding box is processed, the component compares a data field value for that text bounding box with the text information that has been specified for that data field. For example, when a data field value of “name” is encountered, the component looks to see if a prior call to the API has specified a business name. If it has, the current value of the business name is overlaid into the bounding box using the font name, color, drop shadow effect, etc. that was specified for use in the bounding box's XML representation.

During this overlaying process, the system determines the largest possible font size that will fit in the bounding box. If the maximum number of lines that has been specified for this bounding box is one, the system takes a medium font size and measures the size of the string (in terms of the necessary width and height needed to accommodate that string in the font that has been defined for the bounding box) to see if the text fits at that size. If the text does fit the bounding box, the system tries making the font size larger (typically, doubling it) and measures again. It continues this process until the font size is too big to fit. The system then tries at a size that is between the too small and too big sizes using interpolation techniques (successive, gradual refinement) until it finds the largest font size that fits. If the initial font size chosen is too big, the process is similar except that subsequent attempts are made with smaller font sizes until a font size that does fit is found and a similar interpolation is made to determine the largest font size that fits.

If the maximum number of lines that has been specified for this bounding box is greater than one, then the system first determines the largest font size that can be used to render the entire string on one line and makes note of that size. Then, the string is broken into lines such that words are not broken into pieces but that each line is as close to equal length (in terms of number of characters in the line as possible). Therefore, a value of John's Pizza Restaurant would be viewed as 3 tokens consisting of a 6 character word (John's), a 5 character word (Pizza), and another 10 character word (Restaurant). If the maximum number of lines were 2, the string would be laid out as a line of 12 characters (John's Pizza, counting the space) and a line of 10 characters (Restaurant) since the difference is only 2. Once the best line fit is determined, the bounding box size is broken horizontally into as many pieces as lines. Therefore, a bounding box with a height of 30 pixels that needs to make room for 2 lines would render the first line into the top half, 15 pixels high, using the mechanism that fits a single line and the second line would be fit into the bottom half, also 15 pixels high, using the mechanism that fits a single line.

As each image bounding box is processed, the component compares the image bounding box data field with the image information that has been specified for that data field. For example, if the data field value is image1 and the API has been called to specify C:\BadgeImagery\DollarOff.jpg as the image associated with image1, then the badge generation component opens the path/file name specified and determines that it is a file in a recognizable image format (e.g., JPEG, PNG). It then uses information in that image file to determine the image's width and height. If the image's width and height will fit in the bounding box without losing any of the image data (i.e., it fits fully in the box because the bounding box is the same size as or bigger than the image being overlaid), the image is centered horizontally and vertically in the bounding box and overlaid onto the background image. If the specified image is taller and/or wider than the bounding box, the image file is loaded into memory and resized to the largest size that fits the bounding box (preserving the original image's aspect ratio) using interpolation techniques to compare the source width and height with the destination width and height. Once this new size is found, the in-memory representation of the original image is resized to the new desired size and overlaid onto the badge's background image.

When the badge generation component has finished overlaying each bounding box in its representation, the component creates the XML Badge representation that describes this newly created badge. At this point, the call to the badge generation component's OverlayBadge call returns to the calling program.

When the OverlayBadge call returns, the calling program typically calls the badge generation component's WriteBadgeFile API routine giving a path/file name to which the generated graphic file should be saved. While processing this call, the badge generation component saves the in-memory graphic representation of the badge advertisement to the given file name and places the XML Badge representation that was created during the OverlayBadge call in a text comment block in the output file. The output file is then closed and control returns to the calling program. At this time, the badge is available for direct display (typically, as a JPEG file) by a browser and contains all of the information necessary to regenerate the badge at a later point.

When the calling program continues after a successful call to WriteBadgeFile, it can then indicate to other supporting programs that the badge advertisement is ready to be put into use by the online advertising display system. This is accomplished by providing the newly created path/file name to the PublishAd call in the online advertising display system. In its current implementation, the PublishAd call takes the merchant ID associated with the business for which the badge was created and the file/path of the badge. This call triggers an activity that determines where in a folder/file hierarchy the badge should be placed, copies the badge file to that location, and updates its database tables to indicate that this merchant has an advertisement in this location.

The result is that the badge ad is created 60 and stored in a set of badge ads 62. The XML in the badge then allows the badge to be regenerated with new information. The embedded template XML and badge XML are related but different, and together provide the information to create the badge and to regenerate the badge, respectively, without human intervention.

Regeneration of Display Ads

A merchant's name or white pages information may change over time. If the system learns that information about a merchant has changed, whether from notice from the merchant, or though automated means, the system updates the business listing information 63, and also uses the MerchantID to look up information to determine if the merchant has a display ad 64. If so 65, the system gets the current badge including the template and the listing information for the business 66. It then compares the data fields in each of the template's bounding boxes with information in the request 68. If the information that is changed is not displayed 72, no further action is required 74 (this could occur, for example, if the phone number changed but the phone number was not listed on the display ad). If the changed information is listing data that is associated with a data field 70, the system uses the new information to automatically regenerate the ad by repeating the badge creation process 60.

The information with merchant names and identifications can be received in an automated manner, and thus the system can cause the change in ads to occur in an automated manner without manual or other human input.

Additional Features and Advantages

The system and method could also be applied to general online/Internet advertising image creation; any graphic image creation requiring the merging of text and image data including mailing label creation or letterhead creation; and/or real time advertising insertion used in broadcast, local cable, or Interactive TV.

The system and method according to embodiments of the present invention allows a user of the system or method to maximize automatic operations and reduce manual operations, thereby increasing throughput and reducing costs. A method that automatically creates large numbers of display ads from a large set of clip art images and that allows for large variance in the nature, amount, and placement of formatted text is quite useful to an online interactive yellow pages system.

Having described an embodiment of the present invention, it should be apparent that modifications can be made without departing from the scope of the invention as defined by the appended claims. Further aspects and details are in the incorporated provisional application.

1. A method for generating display ads comprising:
selecting a background image for a category of display ads to be displayed online;
defining one or more bounding boxes over each background image for holding text or other images;
on receiving information about an entity and that is to be incorporated into a display ad, automatically selecting a background image based on a category associated with the entity, and automatically inserting the information about the entity into the one or more bounding boxes to create, in an automated manner, the display ad for later display online.

2. The method of claim 1, wherein information received to incorporate into a display ad is received electronically, such that a display ad with a background image and portions of text and/or overlaid images are automatically created without human intervention.

3. The method of claim 1, wherein a textual description of each bounding box is stored in a graphical file format that allows embedded comments.

4. The method of claim 3, wherein the graphical file format is JPEG.

5. The method of claim 1, further comprising displaying the display ad as part of a directory service, wherein selected ones of display ads are displayed along with directory information based on the type of information a user requests from the directory.

6. The method of claim 5, further comprising determining whether a display ad is to be shown on a screen with another display ad having the same background image.

7. The method of claim 6, responsive to a determination that a display ad is similar to another display ad to be displayed on the same page, regenerating in an automated manner a different background image before displaying that display ad.

8. The method of claim 1, further comprising automatically determining whether another display ad for the same category and in a similar geographic area has the same background image as the selected background image prior to creating the display ad, and selecting a different background image if another display ad for the same category has the same background image as the selected background image in the same geographic area.

9. The method of claim 1, further comprising automatically providing a best fit process for incorporating text into bounding boxes by iteratively adjusting the size of the text.

10. The method of claim 1, wherein the bounding boxes have pre-defined size and location and are associated with a background image.

11. The method of claim 1, wherein the size and location of the bounding boxes are separately defined by a user.

12. The method of claim 1, wherein the entity selects its category.

13. The method of claim 1, wherein the category is selected automatically.

14. The method of claim 1, further comprising inserting in a bounding box a graphical image of a coupon.

15. A method for regenerating display ads comprising:
receiving information about an entity for which an online display ad can already be displayed in response to a query;
comparing the received information about the entity to information in a file identifying what information about the party is to be displayed in the online display ad;
if there is a difference between the displayed information and the received information, replacing the displayed information with the received information; and
regenerating the display ad to include the received information and storing it for future display;
wherein the comparing, replacing, and regenerating are all performed in an automated manner.

16. The method of claim 15, further comprising updating information in a database about an entity with the received information without also regenerating an online display ad for that entity if it is determined that the difference in the information is not in information that is displayed in the display ad.

17. A method for generating display ads comprising:
maintaining a plurality of different display ad templates, each template including a background image and regions where information specific to an entity can be inserted for display;
on receiving information about an entity and that is to be incorporated into a display ad, automatically selecting one of the plurality of templates, and automatically inserting the information about the entity into the one or more regions to create, in an automated manner, the display ad for later display online.

18. The method of claim 17, wherein the maintaining includes storing a plurality of templates for each of a plurality of business categories, the method further comprising automatically selecting one of the plurality of templates based on a business category of the entity.

19. The method of claim 17, further comprising displaying the display ad as part of an online yellow pages directory in which users request categories of business in geographical areas.

20. The method of claim 19, further comprising preventing multiple display ads with the same background image from being displayed.

21. The method of claim 1, wherein the background image and bounding boxes define a template, further comprising storing for each template bounding box information identifying what information is to be provided into the bounding boxes when a display ad is created.

22. The method of claim 21, wherein the bounding box information is in extensible markup language (XML).

23. The method of claims 22, wherein the information in XML is stored in a comment portion of a graphical file format.

24. The method of claim 15, wherein the comparing includes comparing a changed data field to tagged information indicating information that is displayed in the display ad.

25. The method of claim 24, wherein the tagged information is in extensible markup language (XML) embedded in a graphical file associated with the display ad.

26. The method of claim 17, further comprising maintaining for each template region information identifying what information is provided in the region.

27. The method of claim 26, wherein the region information is in extensible markup language (XML).

28. The method of claim 9, further comprising automatically providing a best fit process for incorporating graphical images into bounding boxes by scaling the size of the graphical images.

29. The method of claim 1, wherein the automatically inserting information about an entity into a bounding box includes identifying a data field associated with the bounding box, and inserting information from an entity listing matching the data field.
